(19) United States
(12) Patent Application Publication
(10) Pub. No.: US 2025/0335537 A1
(43) Pub. Date: Oct. 30, 2025

(54) ACCELERATION METHOD FOR MATRIX OPERATIONS AND COMPUTING DEVICE

(71) Applicant: Huawei Technologies Co., Ltd., Shenzhen (CN)

(72) Inventors: Fang Gao, Kanata (CA); Xingyu Yue, Kanata (CA); Kai Ting Wang, Kanata (CA); Tarek Saad Abdelrahman, Kanata (CA)

(21) Appl. No.: 18/646,345

(22) Filed: Apr. 25, 2024

(51) Int. Cl. G06F 17/16

(52) U.S. Cl. CPC G06F 17/16

(57) ABSTRACT

An acceleration method for performing matrix operations by a computing device, includes: moving a first slice of a left matrix and a second slice of a right matrix from a host memory to an accelerator memory; moving a third slice of a result matrix from the host memory to the accelerator memory; performing a matrix operation on the first and second slices to obtain a fourth slice of the result matrix; performing a vector operation on the third and fourth slices to obtain a fifth slice of the result matrix; and moving the fifth slice from the accelerator memory to the host memory. The first, second, and fourth slices on the accelerator memory are respectively in a first 4-dimensional (4D) layout, second 4D layout, and third 4D layout. The third slice and the fifth slice are in the same layout on the host memory and the accelerator memory.

### TECHNICAL FIELD

The present disclosure relates to the field of numerical computation technologies for a computing device, and in particular, to an acceleration method for performing matrix operations.

### BACKGROUND

Matrix multiplication (or general matrix multiplication (GEMM)) is an operation task with great importance in a field such as artificial intelligence (AI), high-performance computing (HPC), and scientific computing. Since the computation of matrix multiplication is highly intense, a dedicated accelerator (also called a hardware accelerator, acceleration unit, acceleration device, etc.) may be designed to accelerate the computation.

In order to speed up matrix computations, some accelerators usually operate in units of sub-matrices (e.g., slices, fractals, etc.) smaller than the matrix. However, to effectively increase the computing speed, the accelerator requires the matrix with a four-dimensional (4D) layout, which is different from the layout in the host memory. Thus, the layout conversion needs to be performed.

In light of this, a technical solution is introduced that uses direct memory access (DMA) to perform on-the-fly layout conversion during data transmission. However, this technical solution has a complex control process and requires the design of complex software loops to implement, thus leading to an important performance bottleneck.

### SUMMARY

In a first aspect, an acceleration method for performing matrix operations by a computing device is provided. The computing device includes a host memory and an accelerator memory. The host memory is used for storing a left matrix, a right matrix and a result matrix. The method includes: moving a first slice of the left matrix and a second slice of the right matrix from the host memory to the accelerator memory, wherein the first slice on the accelerator memory is in a first 4-dimensional (4D) layout, and the second slice on the accelerator memory is in a second 4D layout; moving a third slice of the result matrix from the host memory to the accelerator memory; performing a matrix operation on the first slice and the second slice to obtain a fourth slice of the result matrix, wherein the fourth slice on the accelerator memory is in a third 4D layout; performing a vector operation on the third slice and the fourth slice to obtain a fifth slice of the result matrix; and moving the fifth slice from the accelerator memory to the host memory. The third slice and the fifth slice are in the same layout on the host memory and the accelerator memory.

Based on the acceleration method for matrix operations provided in the first aspect, during the matrix operation process, the previous matrix operation result (e.g., the third slice) needs to be moved from the host memory to the accelerator memory, and the vector operation is performed on the previous matrix operation result and the current matrix operation result (e.g., the fourth slice, which may be called an intermediate result) to obtain the current computation result (e.g., the fifth slice), and then the current computation result is moved back to the host memory. Therefore, if the result matrix adopts the same layout on both the host memory and the accelerator memory, then there is no need to use complex data movement instructions to achieve on-the-fly layout conversion during the process of moving each slice of the result matrix between the host memory and the accelerator memory. As a result, a large amount of time consumed by such data movement operations may be reduced, and the computing efficiency is improved.

In a possible implementation, performing the vector operation on the third slice and the fourth slice to obtain the fifth slice of the result matrix, includes: if the third slice and the fourth slice on the accelerator memory are in different layouts, performing a layout conversion operation during the process of performing the vector operation on the third slice and the fourth slice to obtain the fifth slice of the result matrix.

Since the type of vector operation instructions of the accelerator may vary, different instruction parameters may be configured to realize on-the-fly layout conversion of operation data and operation result in the process of vector operation. Therefore, the design of parameters for data movement instructions may be simplified. For example, the data length of a single movement is increased, and the number of times to access data movement resources is reduced. As a result, the time for data movement is saved, and the computing efficiency may be improved.

In a possible implementation, the left matrix is in the same layout on the host memory and the accelerator memory, and/or the right matrix is in the same layout on the host memory and the accelerator memory.

Similar to the above result matrix, when the left matrix and/or the right matrix adopt the same layout on the host memory and accelerator memory, in the process of moving the left matrix and/or the right matrix from the host memory to the accelerator memory, only one or a few data movement instructions need to be designed to realize the data movement, and there is no need for a large number of complex data movement instructions. Thus, it may be possible to save time for data movement and in turn improve the computing efficiency.

In a possible implementation, the left matrix is in different layouts on the host memory and the accelerator memory, and/or the right matrix is in different layouts on the host memory and the accelerator memory. Moving the first slice of the left matrix and the second slice of the right matrix from the host memory to the accelerator memory includes: using one or more first data moving operations to move the first slice of the left matrix from the host memory to the accelerator memory, wherein the one or more first data moving operations are used to convert a layout of the first slice on the host memory into a layout of the first slice on the accelerator memory; and/or, using one or more second data moving operations to move the second slice of the right matrix from the host memory to the accelerator memory, wherein the one or more second data moving operations are used to convert a layout of the second slice on the host memory into a layout of the second slice on the accelerator memory.

In this way, if the left matrix adopts different layouts on the host memory and the accelerator memory and the right matrix adopts different layouts on the host memory and the accelerator memory, by designing applicable data movement instruction(s), the layout conversion is realized during the process of moving the left matrix and right matrix data from the host memory to the accelerator memory, thus satisfying the data computing format requirements of the accelerator. In this way, the data movement operation and the data format conversion operation are combined to save time and improve computing efficiency.

In another possible implementation, the left matrix is in different layouts on the host memory and the accelerator memory, and/or the right matrix is in different layouts on the host memory and the accelerator memory. Before moving the first slice of the left matrix and the second slice of the right matrix from the host memory to the accelerator memory, the method further include: converting a layout of the left matrix or the first slice on the host memory into the first 4D layout; and/or, converting a layout of the right matrix or the second slice on the host memory into the second 4D layout.

In this way, if the left matrix adopts different layouts on the host memory and the accelerator memory and the right matrix adopts different layouts on the host memory and the accelerator memory, then the left matrix and the right matrix may be converted on the host memory to the layout required by the accelerator in advance before the data movement. For example, the host may complete layout conversion in advance during idle time between two adjacent data movements, which saves the time for data movement and computation and in turn improves computing efficiency.

In a possible implementation, the first 4D layout is row major both between and within fractals, the second 4D layout is column major within fractals and row major between fractals, and the third 4D layout is row major within fractals and column major between fractals.

Therefore, based on the resource configuration of the accelerator, such as computing resources (e.g., the number of multipliers, adders, etc.), storage resources (e.g., the number of storage units), computing resource layout requirements, software resources (e.g., types of instructions and configuration parameters), it may be possible to comprehensively design various strategies such as layouts of the left matrix, the right matrix and the result matrix on the accelerator memory and the host memory, data movement instructions, accelerator operation instructions, etc., to improve the operation efficiency as much as possible.

In a possible implementation, the first slice includes one or more first fractals, the second slice includes one or more second fractals, and the third slice, the fourth slice and the fifth slice each include one or more third fractals; the first slice is a bM by bK sub-matrix, the second slice is a bK by bN sub-matrix, and the third slice, the fourth slice and the fifth slice are each a bM by bN sub-matrix; each first fractal is an fM by fK sub-matrix, each second fractal is an fK by fN sub-matrix, and each third fractal is an fM by fN sub-matrix; and mod (bM, fM)=0, mod (bK, fK)=0, and mod (bN, fN)=0.

In this way, the large-scale matrix operations may be divided into multiple sub-matrices (i.e., slices) to make full use of the computing resources, data movement resources, and storage resources to complete the operation and improve efficiency.

In a second aspect, a computing device is provided. The computing device includes: a memory, a host, a host memory, an accelerator, and an accelerator memory; the host memory is used for storing a left matrix, a right matrix and a result matrix; and the memory is configured to store computer instructions that, when executed by the host and the accelerator, cause the computing device to implement: moving a first slice of the left matrix and a second slice of the right matrix from the host memory to the accelerator memory, wherein the first slice on the accelerator memory is in a first 4D layout, and the second slice on the accelerator memory is in a second 4D layout; moving a third slice of the result matrix from the host memory to the accelerator memory; performing a matrix operation on the first slice and the second slice to obtain a fourth slice of the result matrix, wherein the fourth slice on the accelerator memory is in a third 4D layout; performing a vector operation on the third slice and the fourth slice to obtain a fifth slice of the result matrix; and moving the fifth slice from the accelerator memory to the host memory. The third slice and the fifth slice are in the same layout on the host memory and the accelerator memory.

In a possible implementation, the computer instructions that, when executed by the host and the accelerator, cause the computing device to implement: if the third slice and the fourth slice on the accelerator memory are in different layouts, performing a layout conversion operation during the process of performing the vector operation on the third slice and the fourth slice to obtain the fifth slice of the result matrix.

In a possible implementation, the left matrix is in the same layout on the host memory and the accelerator memory; and/or the right matrix is in the same layout on the host memory and the accelerator memory.

In a possible implementation, the left matrix is in different layouts on the host memory and the accelerator memory, and/or the right matrix is in different layouts on the host memory and the accelerator memory; and when the computer instructions that, when executed by the host and the accelerator, cause the computing device to implement: using one or more first data moving operations to move the first slice of the left matrix from the host memory to the accelerator memory, wherein the one or more first data moving operations are used to convert a layout of the first slice on the host memory into a layout of the first slice on the accelerator memory; and/or, using one or more second data moving operations to move the second slice of the right matrix from the host memory to the accelerator memory, wherein the one or more second data moving operations are used to convert a layout of the second slice on the host memory into a layout of the second slice on the accelerator memory.

In another possible implementation, the left matrix is in different layouts on the host memory and the accelerator memory, and/or the right matrix is in different layouts on the host memory and the accelerator memory; and the computer instructions that, when executed by the host and the accelerator, cause the computing device to further implement: before moving the first slice of the left matrix and the second slice of the right matrix from the host memory to the accelerator memory, converting a layout of the left matrix or the first slice on the host memory into the first 4D layout and/or converting a layout of the right matrix or the second slice on the host memory into the second 4D layout.

In a possible implementation, the first 4D layout is row major both between and within fractals, the second 4D layout is column major within fractals and row major between fractals, and the third 4D layout is row major within fractals and column major between fractals.

In a possible implementation, the first slice includes one or more first fractals, the second slice includes one or more second fractals, and the third slice, the fourth slice and the fifth slice each include one or more third fractals; the first slice is a bM by bK sub-matrix, the second slice is a bK by bN sub-matrix, and the third slice, the fourth slice and the fifth slice are each a bM by bN sub-matrix; each first fractal is an fM by fK sub-matrix, each second fractal is an fK by fN sub-matrix, and each third fractal is an fM by fN sub-matrix; and mod (bM, fM)=0, mod (bK, fK)=0, and mod (bN, fN)=0.

In a third aspect, a non-transitory computer-readable storage medium is provided, having instructions stored thereon, which when executed by a computing device including a host memory and an accelerator memory, causes the computing device to perform a method including: moving a first slice of a left matrix and a second slice of a right matrix from the host memory to the accelerator memory, wherein the first slice on the accelerator memory is in a first 4D layout, and the second slice on the accelerator memory is in a second 4D layout; moving a third slice of a result matrix from the host memory to the accelerator memory; performing a matrix operation on the first slice and the second slice to obtain a fourth slice of the result matrix, wherein the fourth slice on the accelerator memory is in a third 4D layout; performing a vector operation on the third slice and the fourth slice to obtain a fifth slice of the result matrix; and moving the fifth slice from the accelerator memory to the host memory. The third slice and the fifth slice are in the same layout on the host memory and the accelerator memory.

In a possible implementation, the instructions that, when executed by the computing device, cause the computing device to implement: if the third slice and the fourth slice on the accelerator memory are in different layouts, performing a layout conversion operation during the process of performing the vector operation on the third slice and the fourth slice to obtain the fifth slice of the result matrix.

In a possible implementation, the left matrix is in the same layout on the host memory and the accelerator memory; and/or the right matrix is in the same layout on the host memory and the accelerator memory.

In a possible implementation, the left matrix is in different layouts on the host memory and the accelerator memory and/or the right matrix is in different layouts on the host memory and the accelerator memory; and the instructions that, when executed by the computing device cause the computing device to implement: using one or more first data moving operations to move the first slice of the left matrix from the host memory to the accelerator memory, wherein the one or more first data moving operations are used to convert a layout of the first slice on the host memory into a layout of the first slice on the accelerator memory; and/or, using one or more second data moving operations to move the second slice of the right matrix from the host memory to the accelerator memory, wherein the one or more second data moving operations are used to convert a layout of the second slice on the host memory into a layout of the second slice on the accelerator memory.

In another possible implementation, the left matrix is in different layouts on the host memory and the accelerator memory and/or the right matrix is in different layouts on the host memory and the accelerator memory; and the instructions that, when executed by the computing device, cause the computing device to further implement: before moving the first slice of the left matrix and the second slice of the right matrix from the host memory to the accelerator memory, converting a layout of the left matrix or the first slice on the host memory into the first 4D layout and/or converting a layout of the right matrix or the second slice on the host memory into the second 4D layout.

In a possible implementation, the first 4D layout is row major both between and within fractals, the second 4D layout is column major within fractals and row major between fractals, and the third 4D layout is row major within fractals and column major between fractals.

In a possible implementation, the first slice includes one or more first fractals, the second slice includes one or more second fractals, and the third slice, the fourth slice and the fifth slice each include one or more third fractals; the first slice is a bM by bK sub-matrix, the second slice is a bK by bN sub-matrix, and the third slice, the fourth slice and the fifth slice are each a bM by bN sub-matrix; each first fractal is an fM by fK sub-matrix, each second fractal is an fK by fN sub-matrix, and each third fractal is an fM by fN sub-matrix; and mod (bM, fM)=0, mod (bK, fK)=0, and mod (bN, fN)=0.

In a fourth aspect, a computer program product is provided, including instructions carried on a non-transitory computer-readable storage medium. The instructions, when executed by a computing device, cause the computing device to implement the acceleration method for matrix operations provided in any implementation in the above first aspect.

In a fifth aspect, a system on chip (SoC) is provided. The SoC includes a processing circuit and a non-transitory storage medium. The storage medium has computer program instructions stored thereon that, when executed by the processing circuit, cause the SoC to implement the acceleration method for matrix operations provided in any implementation in the above first aspect.

### BRIEF DESCRIPTION OF THE DRAWINGS

FIG. 1 is a schematic diagram showing a 2-dimensional (2D) layout and a 4-dimensional (4D) layout in the related art;

FIG. 2 is a box diagram showing a structure of a computing device, in accordance with embodiments of the present disclosure;

FIG. 3 is a schematic diagram showing an architecture of the computing system in FIG. 2;

FIG. 4 is a schematic diagram showing a slice-based matrix multiplication process, in accordance with embodiments of the present disclosure;

FIG. 5 is a flow diagram of an acceleration method for matrix operations, in accordance with embodiments of the present disclosure;

FIGS. 6A to 6D are diagrams showing processes of moving a slice of a left matrix A from a host memory to an accelerator memory, in accordance with embodiments of the present disclosure;

FIG. 7 is a diagram showing a process of moving a slice of a right matrix B from a host memory to an accelerator memory, in accordance with embodiments of the present disclosure;

FIG. 8 is an example of moving a slice of the result matrix C from the host to the accelerator, in accordance with embodiments of the present disclosure;

FIG. 9 is a schematic diagram 2 of slice-based matrix multiplication, in accordance with embodiments of the present disclosure;

FIGS. 10A and 10B are schematic diagrams showing a slice-based vector addition, in accordance with embodiments of the present disclosure; and

FIG. 11 is a schematic diagram showing a process of moving a slice of a result matrix C from an accelerator memory to a host memory, in accordance with embodiments of the present disclosure.

### DETAILED DESCRIPTION OF ILLUSTRATIVE EMBODIMENTS

Technical terms involved in embodiments of the present disclosure are described before introducing the embodiments of the present disclosure.

### 1. Matrix Multiplication Via Sub-Matrix Multiplication

To speed up matrix computations, some accelerators generally operate in units of sub-matrices smaller than a matrix. For example, a large matrix multiplication computation can be decomposed into multiple small sub-matrix multiplication computations; and for each computation, data required for a small sub-matrix multiplication computation is moved from a host memory to an accelerator memory to complete the sub-matrix multiplication computation, and then a sub-matrix multiplication result is moved back to the host memory. The above-mentioned small sub-matrices may include slices, fractals, etc.

### 2.2-Dimensional (2D) Layout of Matrix and 4-Dimensional (4D) Layout of Matrix

The host memory generally occupies a linear address space, which may be treated as a large one-dimensional (1D) array. The matrix is essentially a 2D array, which means that the matrix needs to be mapped to the memory in a certain way for storage. For example, 2D layout and 4D layout can be adopted.

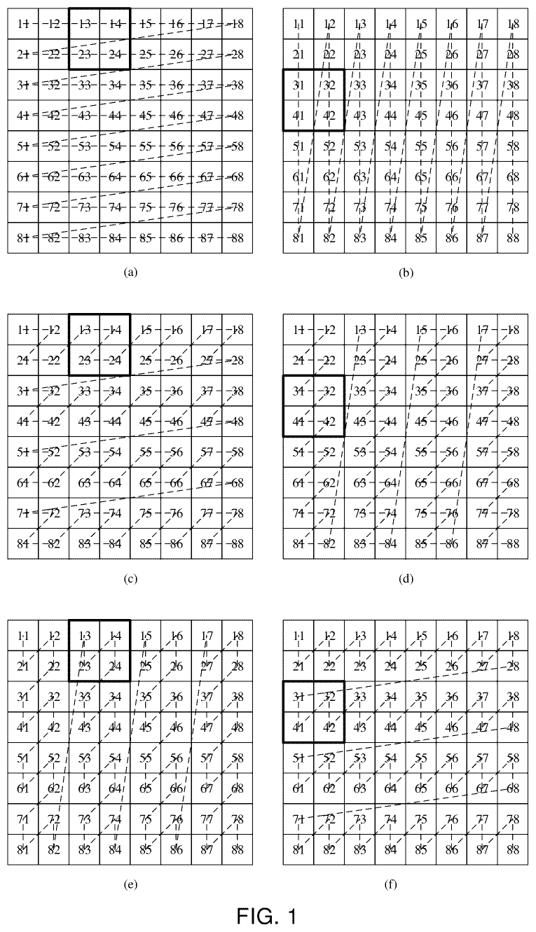

As shown in (a) and (b) in FIG. 1, the 2D layout traverses the matrix in a certain direction and starts from a next row/column when a current row/column ends. The 2D layout may include two mapping orders: row-major order and column-major order. The difference between the two orders lies in which elements of the matrix are contiguous in memory. For example, in row-major order, elements of the same row in the matrix are contiguous in memory; and in column-major order, elements of the same column in the matrix are contiguous in memory. The dotted lines shown in (a) and (b) in FIG. 1 vividly describe the situation where the matrix is continuous by rows or columns. Therefore, the layout in row-major order may also be vividly described as Z layout, and the layout in column-major order may be vividly described as N layout.

As shown in (c) to (f) in FIG. 1, the 4D layout traverses the elements inside the fractal firstly and then traverses between fractals. The matrix may be traversed in four possible orders: row-major inside fractals and row-major between fractals, row-major inside fractals and column-major between fractals, column-major inside fractals and column-major between fractal, and column-major inside fractals and row-major between fractals. The dotted lines shown in (c) to (f) in FIG. 1 vividly describe the above four 4D layouts. Therefore, the four 4D layouts may also be vividly described as zZ layout, zN layout, and nN layout, and nZ layout, respectively.

### 3. Layout Conversion

In order to improve the resource utilization efficiency of the accelerator, a special 4D layout scheme is usually designed for the accelerator, which may be different from the layout of the matrix in the host memory. Therefore, the layout conversion is required during the process of moving the sub-matrix from the host memory to the accelerator memory for matrix operations.

For matrix multiplication operations, some accelerators require the matrix in 4D layout to effectively increase the computation speed, but the matrix in the host memory usually adopts a different layout, such as a 2D layout. That is, the accelerator cannot directly use matrix data read from the host memory to perform operations, so that the layout conversion needs to be performed.

In a general solution, the entire matrix is converted from a 2D layout to a 4D layout before the matrix multiplication operation is performed, and then a computation result is converted back to a 2D layout. This solution can be achieved by providing additional format conversion cores on the host and/or the accelerator, which requires additional data transmission time and data storage space, thus reducing data format conversion efficiency and matrix computation efficiency.

In addition, a technical solution using direct memory access (DMA) for on-the-fly format conversion during data transmission is also introduced to avoid costs of format conversion on the host and/or accelerator. However, this technical solution has a complex control process and requires the design of complex software loops to implement, thus leading to an important performance bottleneck.

For example, in some scenarios such as LU decomposition, when the number of rows of a left matrix is much larger than the number of columns of the left matrix, and the number of columns of a right matrix is much larger than the number of rows of the right matrix, a result matrix may be very large. If the result matrix adopts different layouts on the host memory and the accelerator memory, then in the process of moving the result matrix back and forth between the host memory and the accelerator memory, a large number of complex data movement instructions (such as DMA instructions) are required to implement the data movement and format conversion of the result matrix, which will cause a lot of additional software overhead and in turn reduce the computing efficiency.

In order to solve the above problems, some embodiments of the present disclosure provide an acceleration method for matrix operations and a computing device.

The technical solutions in the embodiments of the present disclosure will be described in details below with reference to the accompanying drawings.

The technical solutions provided in the embodiments of the present disclosure can be applied to various computing devices involved in a large number of matrix operations, such as AI systems, HPC devices, and scientific computing devices.

The present disclosure will introduce various aspects, embodiments, or features in terms of systems, which may include multiple devices, components, modules, etc. It should be understood and appreciated that various systems may include additional devices, components, modules, etc., and/or may not include all devices, components, modules, etc. discussed in connection with the figures. Additionally, a combination of these scenarios can be used.

Unless the context requires otherwise, throughout the description and the claims, the term “comprise” and other forms thereof such as the third-person singular form “comprises” and the present participle form “comprising” are construed as open and inclusive meaning, i.e., “including, but not limited to”. In the description, the terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials or characteristics may be included in any one or more embodiments or examples in any suitable manner. In addition, in the embodiments of the present disclosure, the term such as “optionally”, “exemplary” or “for example” are used to present an example, illustration, or explanation. Any embodiment or design solution described herein with “optionally”, “exemplary” or “for example” in the embodiments of the present disclosure is not necessarily to be construed as preferred or advantageous over other embodiments or design solutions. Rather, the use of the words/phrases such as “optionally”, “exemplary” or “for example” is intended to present relevant concepts in a specific manner.

In the embodiments of the present disclosure, the terms such as “of”, “relevant” and “corresponding” may sometimes be used interchangeably. It should be noted that when the difference is not emphasized, the intended expression is consistent.

The computing architecture and business scenarios described in the embodiments of this application are to more clearly explain the technical solutions of the embodiments of this application, and do not constitute a limitation on the technical solutions provided by the embodiments of this application. Those of ordinary skill in the art will know that with the evolution of computing architecture and the emergence of new business scenarios, the technical solutions provided in the embodiments of the present disclosure are also applicable to similar technical problems.

The term “and/or” merely describes an association of associated objects, which include three situations. For example, “A and/or B” refers to three situations: A alone, A and B, and B alone.

Hereinafter, the terms “first” and “second” are used for descriptive purposes only, and are not to be construed as indicating or implying the relative importance or implicitly indicating the number of indicated technical features. Thus, features defined with “first” and “second” may explicitly or implicitly include one or more of the features, and the terms “first” and “second” are not used to describe a specific order of the objects.

In the description of the embodiments of the present disclosure, the term “multiple”, “a plurality of” or “the plurality of” means two or more unless otherwise specified, and “multiple”, “a plurality of” or “the plurality of” may also be described as “at least two”.

As used herein, the term “if” is, optionally, construed as “when”, “in a case where”, “in response to determining” or “in response to detecting”, depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]”, depending on the context.

The use of the phrase “applicable to” or “configured to” herein means an open and inclusive language, which does not exclude devices that are applicable to or configured to perform additional tasks or steps.

In addition, the phrase “based on” used herein has an open and inclusive meaning, since a process, step, calculation or other action that is “based on” one or more of the stated conditions or values may, in practice, be based on additional conditions or values exceeding those stated.

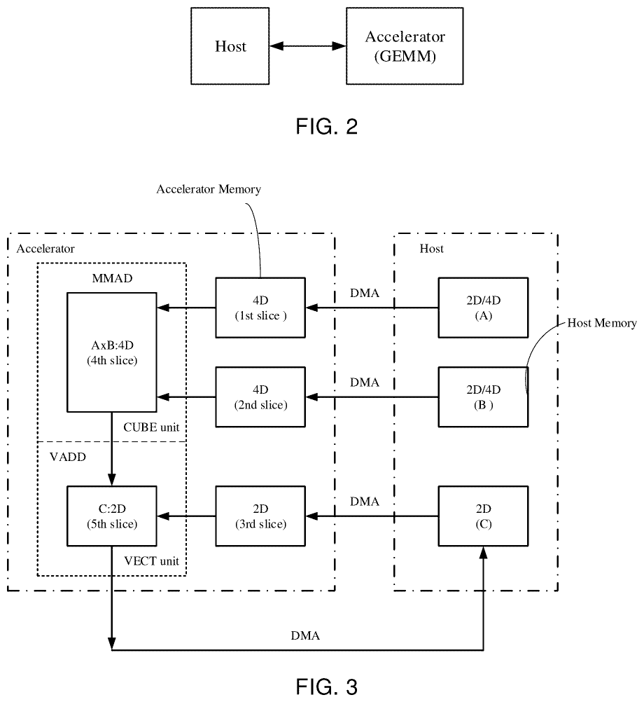

In order to facilitate understanding of the embodiments of the present disclosure, firstly, the computing system used in the embodiments of the present disclosure will be described in detail by taking the computing system shown in FIG. 2 as an example.

FIG. 2 is a schematic diagram showing a structure of a computing device applicable for the acceleration method for matrix operations provided in the embodiments of the present disclosure. As shown in FIG. 2, the computing device includes a host and an accelerator.

The host is used to schedule computing tasks. The accelerator is used to complete the computing tasks according to scheduling instruction(s) of the host and return a computing result to the host. For example, the host sends one or more computing instructions to the accelerator, and the one or more computing instructions are used to instruct the accelerator to complete a corresponding computing task. Accordingly, the accelerator may return the computing result (including an intermediate result and a final result) to the host.

The host may be a general processor. The accelerator may be a specific processor or specific integrated circuit, a field programmable gate array, etc. for accelerating massive matrix operations, for example, cube units in Ascend processor and tensor cores in graphic processing units (GPUs), and matrix units in tensor processing units (TPUs).

Optionally, the computing device may include one or more host memories and one or more accelerator memories. The one or more host memories and the one or more accelerator memories may be arranged independently, the one or more host memories are coupled with the host, and the one or more accelerator memories are coupled with the accelerator. Alternatively, the one or more host memories, the one or more accelerator memories, the host and the accelerator may be integrated together in the computing device. The embodiments of the present disclosure are not limited thereto.

The host memory is used to store a left matrix, a right matrix, and a result matrix. The host memory is a memory that the host can directly access and the accelerator cannot access. The accelerator memory is a memory that the accelerator can directly access and the host needs to call a driver program to indirectly access.

FIG. 3 illustrates an example of the computing device in FIG. 2. As shown in FIG. 3, the accelerator includes one or more matrix multiplication circuits and a plurality of accelerator memories, the accelerator memories are each used for storing data of a slice read from the host memory for participating in the matrix multiplication operation, such as a first slice of the left matrix A, a second slice of the right matrix B, a third slice of the result matrix C (e.g., a previous computation result or an initial value), and a fourth slice of the result matrix C (e.g., a current matrix multiplication result). The one or more host memories may be a single memory, the single memory may include a plurality of storage spaces, and the plurality of storage spaces are respectively used for storing elements of the left matrix A, elements of the right matrix B, and elements of the result matrix C. Alternatively, the one or more host memories may include a plurality of memories, and the plurality of memories are respectively used for storing elements of the left matrix A, elements of the right matrix B, and elements of the result matrix C.

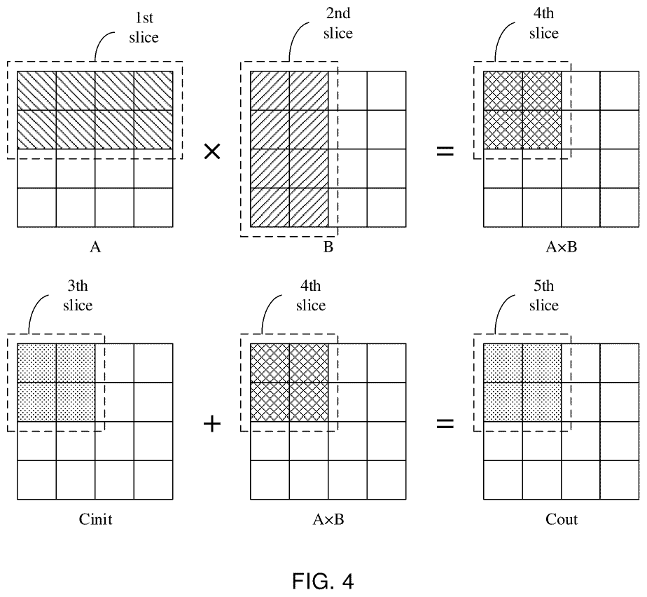

One slice may include one or more fractals. FIG. 4 illustrates an example of sub-matrix multiplication operation provided in the embodiments of the present disclosure. As shown in FIG. 4, to obtain a computation result (e.g., a fifth slice) of one slice in the result matrix C, one slice (e.g., the first slice) of the left matrix A and one slice (e.g., the second slice) of the right matrix B need to be moved to the accelerator memory to perform a matrix multiplication operation, a matrix product (e.g., a fourth slice) and one slice of the result matrix C (i.e., the third slice, or a previous computation result or an initial value, denoted as Cinit) that is read in the accelerator are added to obtain a current matrix product (e.g., the fifth slice, denoted as Cout), and the fifth slice is moved back to the host memory for storage.

It should be understood that FIGS. 2 and 3 are only simplified schematic diagrams for ease of understanding. The computing device may also include other components, which are not shown in FIGS. 2 and 3.

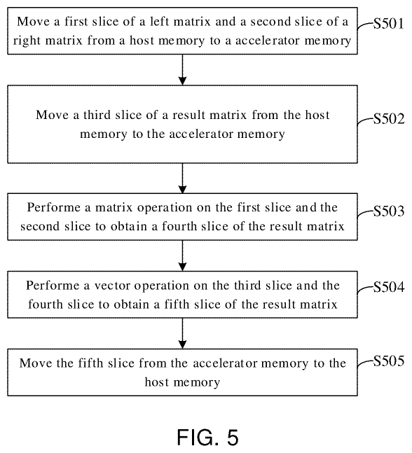

The acceleration method for matrix operations provided in the embodiments of the present disclosure will be described below in combination with FIGS. 3 to 11.

For example, FIG. 3 is a schematic flow diagram of the acceleration method for matrix operations provided in the embodiments of the present disclosure. This method can be applied to implement matrix operations in the computing device shown in FIG. 2 or 3.

As shown in FIG. 3, the acceleration method for matrix operations includes the following steps S501 to S505.

In S501, the first slice of the left matrix and the second slice of the right matrix are moved from the host memory to the accelerator memory. The first slice on the accelerator memory is in a first 4D layout, and the second slice on the accelerator memory is in a second 4D layout.

In S502, the third slice of the result matrix is moved from the host memory to the accelerator memory.

In S503, a matrix operation is performed on the first slice and the second slice to obtain the fourth slice of the result matrix. The fourth slice on the accelerator memory is in a third 4D layout.

In S504, a vector operation is performed on the third slice and the fourth slice to obtain the fifth slice of the result matrix.

In S505, the fifth slice is moved from the accelerator memory to the host memory. The third slice and the fifth slice are in the same layout on the host memory and the accelerator memory.

Based on the acceleration method for matrix operations provided in the embodiments of the present disclosure, during the matrix operation process, the previous matrix operation result (e.g., the third slice) needs to be moved from the host memory to the accelerator memory, and the vector operation is performed on the previous matrix operation result and the current matrix operation result (e.g., the fourth slice, which can be called an intermediate result) to obtain the current computation result (e.g., the fifth slice), and then the current computation result is moved back to the host memory. Therefore, if the result matrix adopts the same layout on both the host memory and the accelerator memory, then there is no need to use complex data movement instructions to achieve on-the-fly layout conversion during the process of moving each slice of the result matrix between the host memory and the accelerator memory. As a result, a large amount of time consumed by such data movement operations may be reduced, and the computing efficiency is improved.

The matrix operation may include, but are not limited to, matrix addition, matrix multiplication, matrix division, etc. The vector operation may include, but are not limited to, vector addition, vector inner product, vector cross product, etc. The data movement instructions may include direct memory access (DMA) instructions.

In some embodiments, the first slice includes one or more first fractals; the second slice includes one or more second fractals; and the third slice, the fourth slice and the fifth slice each include one or more third fractals. The first slice is a bM by bK sub-matrix, the second slice is a bK by bN sub-matrix, and the third slice, the fourth slice and the fifth slice are each a bM by bN sub-matrix. Each first fractal is an fM by fK sub-matrix, each second fractal is an fk by fN sub-matrix, and each third fractal is an fM by fN sub-matrix, where mod (bM, fM)=0, mod (bK, fK)=0, and mod (bN, fN)=0. In this way, a large-scale matrix operation may be performed by decomposing the matrix into multiple sub-matrices (i.e., slices), so as to make full use of the computing resources, data movement resources, and storage resources to complete the operation and improve efficiency. In order to simplify the process, the first to third fractals may be square matrices, and fM, fK, fN and Nf are all equal (fM=fK=fN=Nf) at this time.

With reference to FIG. 3, as for S501, regarding whether the left matrix and the right matrix adopt the same layout on the host memory and the accelerator memory, the following data movement manners may be used.

In some embodiments, the left matrix adopts different layouts on the host memory and the accelerator memory, and/or the right matrix adopts different layouts on the host memory and the accelerator memory; and S501 in which the first slice of the left matrix and the second slice of the right matrix are moved from the host memory to the accelerator memory may include:
using one or more first data moving operations to move the first slice of the left matrix from the host memory to the accelerator memory, where the one or more first data moving operations are used to convert a layout of the first slice on the host memory into a layout of the first slice on the accelerator memory; and/or
using one or more second data moving operations to move the second slice of the right matrix from the host memory to the accelerator memory, where the one or more second data moving operations are used to convert a layout of the second slice on the host memory into a layout of the second slice on the accelerator memory.

In other words, if the left matrix adopts different layouts on the host memory and the accelerator memory and the right matrix adopts different layouts on the host memory and the accelerator memory, by designing applicable data movement instruction(s), the layout conversion is realized during the process of moving the left matrix and right matrix data from the host memory to the accelerator memory, thus satisfying the data computing format requirements of the accelerator. In this way, the data movement and the data format conversion are combined to save time and improve computing efficiency.

Considering the left matrix A and the first data moving operation(s) as an example, the left matrix A is of a size of M by K (M×K), and is in Z layout on the host memory and in zZ layout on the accelerator memory; the first slice is of a size of bM by bK (bM×bK); and each fractal is a square matrix of Nf by Nf (Nf×Nf). Therefore, the first data moving operation(s) can be used to realize on-the-fly layout conversion during the process of moving the first slice of the left matrix A from the host memory to the accelerator memory.

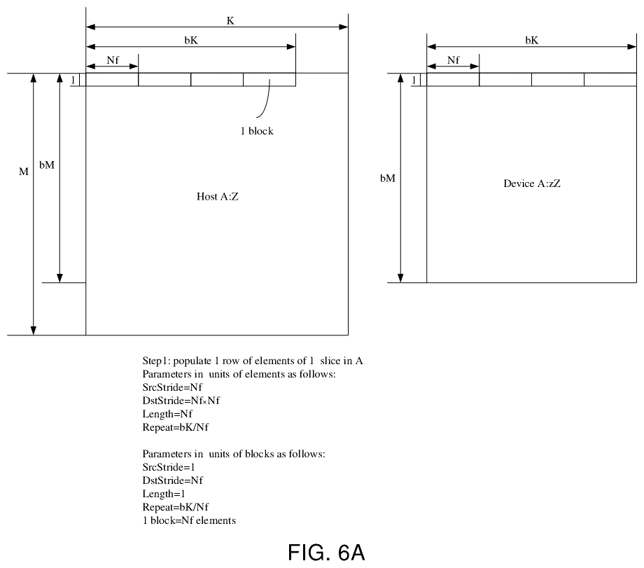

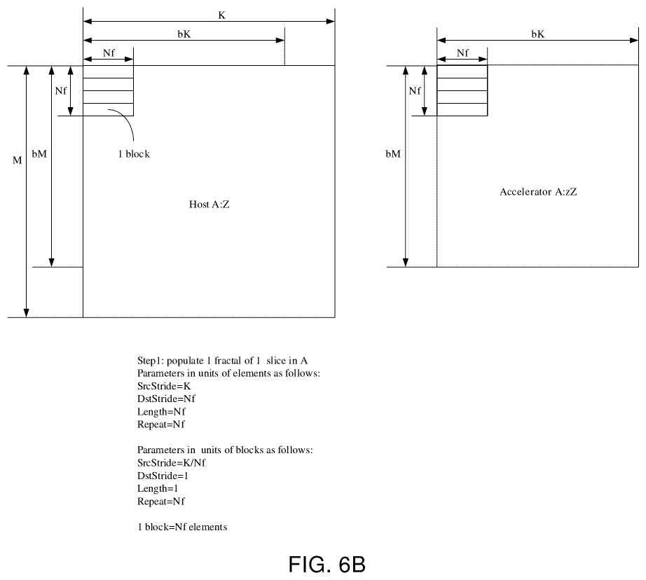

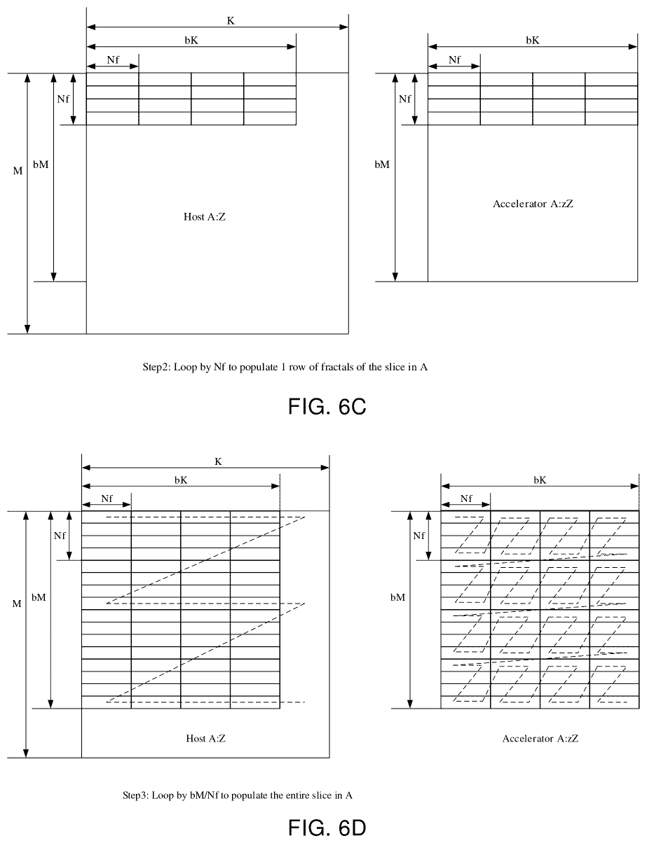

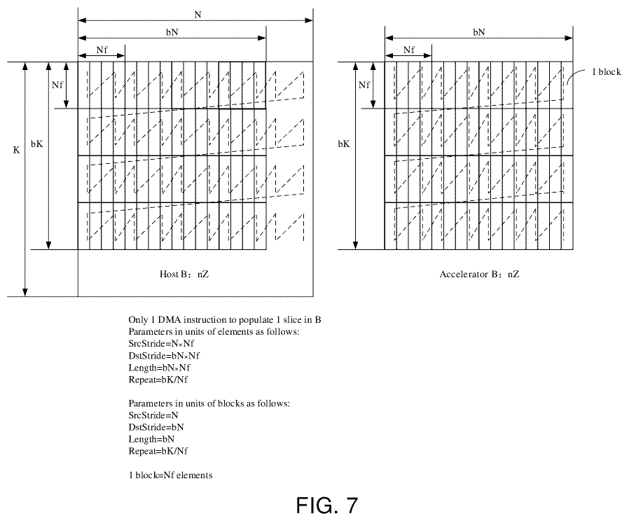

Considering the DMA instruction(s) as an example, the first data moving operation(s) will be described in detail below in conjunction with two examples shown in FIGS. 6A to 6D. FIGS. 6A, 6C and 6D shows Example 1 of the first data moving operation(s). FIGS. 6B, 6C and 6D shows Example 2 of the first data moving operation(s).

Referring to FIGS. 6A, 6C and 6D, Example 1 of the first data moving operation(s) includes the following steps.

In step 1, as shown in FIG. 6A, a row of elements in the first slice is moved from the host memory to the accelerator memory.

In step 2, as shown in FIG. 6C, a row of fractals in the first slice is moved from the host memory to the accelerator memory by repeating the step 1 Nf times.

In step 3, as shown in FIG. 6D, all rows of fractals in the first slice are moved from the host memory to the accelerator memory by repeating the step 2 (bM/Nf) times.

The above step 1 may be implemented using one DMA instruction, and a total of bM DMA instructions are required for moving the first slice. The parameter configuration of an i-th DMA instruction (where i is greater than or equal to 1 and less than or equal to bM (1≤i≤bM)) is as follows:

(1) DMA instruction in units of elements has the following parameters:
SrcStride=Nf, which means that the source stride is Nf, which means that the number of elements between two adjacent repeats on the host memory is Nf;
DstStride=Nf×Nf, which means that the destination stride is Nf×Nf, which means that the number of elements between two adjacent repeats on the accelerator memory is Nf×Nf;
Length=Nf, which means that the number of elements that can be moved by one repeat of the i-th DMA instruction is Nf, which means that Nf elements, in a certain fractal, of the i-th row of elements in the first slice is moved by one repeat of the i-th DMA instruction; and
Repeat=bK/Nf, which means that the i-th DMA instruction repeats bK/Nf times, which means that a row of elements in the first slice spans (bK/Nf) fractals and (bK/Nf) repeats are needed.

(2) DMA instruction in units of blocks has the following parameters:
SrcStride=1, which means that the source stride is 1, which means that the number of blocks between two adjacent repeats on the host memory is 1;
DstStride=Nf, which means that the destination stride is Nf, which means that the number of blocks between two adjacent repeats on the accelerator memory is Nf;
Length=1, which means that the number of blocks that can be moved by one repeat of the i-th DMA instruction is 1; and
Repeat=bK/Nf, which means that the i-th DMA instruction repeats bK/Nf times.

Here, one block includes Nf elements (1 block=Nf elements). The block refers to a block that can be read by one repeat of the DMA instruction based on the DMA protocol, and it can be represented by the amount of data contained in the block. For example, if one block is 32 bytes and one element is 2 bytes, then one repeat of the DMA instruction can read 16 consecutively stored elements.

Referring to FIGS. 6B, 6C and 6D, Example 2 of the first data moving operation includes the following steps.

In step 1, as shown in FIG. 6B, a fractal of the first slice is moved from the host memory to the accelerator memory by one repeat of the DMA instruction.

In step 2, as shown in FIG. 6C, a row of fractals in the first slice is moved from the host memory to the accelerator memory by repeating the step 1 Nf times.

In step 3, as shown in FIG. 6D, all rows of fractals in the first slice are moved from the host memory to the accelerator memory by repeating the step 2 (bM/Nf) times.

The above step 1 may be implemented using one DMA instruction, and a total of (bM×bN)/(Nf×Nf)DMA instructions are required. The parameter configuration of a j-th DMA instruction (where 1≤j≤Nf) is as follows:

(1) DMA instruction in units of elements has the following parameters:
SrcStride=K, which means that the source stride is K, which means that the number of elements between two adjacent repeats on the host memory is K;
DstStride=Nf, which means that the destination stride is Nf, which means that the number of elements between two adjacent repeats on the accelerator memory is Nf;
Length=Nf, which means that the number of elements that can be moved by one repeat of the j-th DMA instruction is Nf, which means that Nf elements in a row in a j-th fractal in the first slice can be moved by one repeat of the j-th DMA instruction; and
Repeat=Nf, which means that the j-th DMA instruction repeats Nf, which means that a fractal in the first slice has Nf rows of elements and Nf repeats are needed.

(2) DMA instruction in units of blocks has the following parameters:
SrcStride=K/Nf, which means that the source stride is K/Nf, which means that the number of blocks between two adjacent repeats on the host memory is K/Nf;
DstStride=1, which means that the destination stride is 1, which means that the number of blocks between two adjacent repeats on the accelerator memory is 1;
Length=1, which means that the number of blocks that can be moved by one repeat of the j-th DMA instruction is 1; and
Repeat=Nf, which means that the j-th DMA instruction repeats Nf times.

Here, the size of the block in Example 2 is the same as the size of the block in Example 1, which will not be repeated here.

It should be noted that, for the above-mentioned first data moving operation(s), in addition to the data movement solutions described in Example 1 and Example 2, other technical solutions may also be designed, which are not limited in the embodiments of the present disclosure.

In some other embodiments, the left matrix is in different layouts on the host memory and the accelerator memory, and/or the right matrix is in different layouts on the host memory and the accelerator memory. Correspondingly, before moving the first slice of the left matrix and the second slice of the right matrix from the host memory to the accelerator memory (S501), the method may further include:
converting a layout of the left matrix or the first slice on the host memory into the first 4D layout; and/or
converting a layout of the right matrix or the second slice on the host memory into the second 4D layout.

In other words, if the left matrix adopts different layouts on the host memory and the accelerator memory and the right matrix adopts different layouts on the host memory and the accelerator memory, then the left matrix and the right matrix can be converted on the host memory to the layout required by the accelerator in advance before the data movement. For example, the host may complete layout conversion in advance during idle time between two adjacent data movements, which saves the time for data movement and computation and in turn improves computing efficiency.

It should be noted that in the case where the left matrix adopts different layouts on the host memory and accelerator memory and the right matrix adopts different layouts on the host memory and accelerator memory, the layout conversion is required, and it is possible to flexibly determine the strategy of data movement and layout conversion by considering the time spent on both the on-the-fly layout conversion during data movement and the layout conversion performed in advance on the host memory. For example, all data may be subjected to the layout conversion in advance on the host memory, or all data may be subjected to the layout conversion during data movement, or part of data may be subjected to the layout conversion in advance on the host memory and another part of data may be subjected to the layout conversion during data movement, which will not be limited in the embodiments of the present disclosure.

In some embodiments, the left matrix is in the same layout on the host memory and the accelerator memory, and/or the right matrix is in the same layout on the host memory and the accelerator memory. That is to say, the left matrix and/or the right matrix adopts the same layout on the host memory and the accelerator memory. That is, the layout of the left matrix and/or the right matrix on the host memory can be set as the layout required by the accelerator. In this way, in the process of moving the left matrix and/or the right matrix from the host memory to the accelerator memory, only one or a few data movement instructions need to be designed to realize the data movement, and there is no need for a large number of complex data movement instructions. Thus, it may be possible to save time for data movement and data format conversion, and in turn improve the computing efficiency.

For example, if the accelerator memory requires the left matrix to adopt zZ layout and the right matrix to adopt nZ layout, then the layout of the left matrix on the host memory is set to zZ layout and the layout of the right matrix on the host memory is set to nZ layout; therefore, only one DMA instruction is required for moving sub-matrix data, required by the accelerator for one computation, from the host memory to the accelerator memory.

For example, the size of the right matrix B is K×N, and the right matrix B is in nZ layout on both the host memory and the accelerator memory; and the size of the second slice is bK×bN, and each fractal is a square matrix of Nf×Nf. Since the right matrix B adopts nZ layout on both the host memory and the accelerator memory, no layout conversion is required and one DMA instruction can complete the moving operation of the second slice.

As shown in FIG. 7, the parameter configuration of the one DMA instruction is as follows:

(1) DMA instruction in units of elements has the following parameters:
SrcStride=N×Nf, which means that the source stride is N×Nf, which means that the number of elements between two adjacent repeats on the host memory is N×Nf;
DstStride=bN×Nf, which means that the destination stride is bN×Nf, which means that the number of elements between two adjacent repeats on the accelerator memory is bN×Nf;
Length=bN×Nf, which means that the number of elements that can be moved by one repeat of the DMA instruction is bN×Nf, which means that the number of elements in a row of fractals in the second slice is bN×Nf; and
Repeat=bK/Nf, which means that the DMA instruction repeats bK/Nf times, which means that the second slice has (bK/Nf) rows of fractals and (bK/Nf) repeats are needed.

(2) DMA instruction in units of blocks has the following parameters:
SrcStride=N, which means that the source stride is N, which means that the number of blocks between two adjacent repeats on the host memory is N;
DstStride=bN, which means that the destination stride is bN, which means that the number of blocks between two adjacent repeats on the accelerator memory is bN;
Length=bN, which means that the number of blocks that can be moved by one repeat is bN;
Repeat=bK/Nf, which means repeating bK/Nf times.

As for S502, in the embodiments of the present disclosure, the result matrix Cis in the same layout on the host memory and the accelerator memory. Therefore, only one DMA instruction is needed to move the third slice of the result matrix C from the host memory to the accelerator memory.

For example, the size of the result matrix C is M×N, and the result matrix C adopts Z layout on both the host memory and the accelerator memory; and the size of the third slice is bM×bN, and each fractal is a square matrix of Nf×Nf. Since the result matrix C adopts Z layout on both the host memory and the accelerator memory, no layout conversion is required, and one DMA instruction can complete the moving operation of all elements in the third slice.

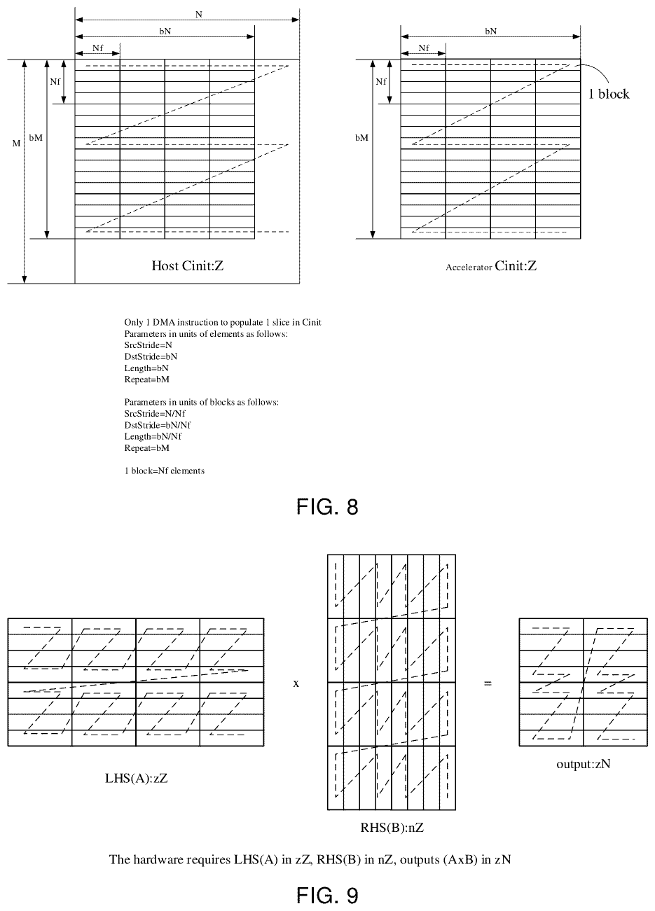

As shown in FIG. 8, the parameter configuration of the one DMA instruction is as follows:

(1) DMA instruction in units of elements has the following parameters:
SrcStride=N, which means that the source stride is N, which means that the number of elements between two adjacent repeats on the host memory is N;
DstStride=bN, which means that the destination stride is bN, which means that the number of elements between two adjacent repeats on the accelerator memory is bN;
Length=bN, which means that the number of elements that can be moved by one repeat of the DMA instruction is bN, which means a row of elements in the third slice; and
Repeat=bM, which means that the DMA instruction repeats bM times, which means that the third slice has bM rows of elements and bM repeats are needed.

(2) DMA instruction in units of blocks has the following parameters:
SrcStride=N/Nf, which means that the source stride is N/Nf, which means that the number of blocks between two adjacent repeats on the host memory is N/Nf;
DstStride=bN/Nf, which means that the destination stride is bN/Nf, which means that the number of blocks between two adjacent repeats on the accelerator memory is bN/Nf;
Length=bN/Nf, which means that the number of blocks that can be moved by one repeat of the DMA instruction is bN/Nf; and
Repeat=bM, which means that the DMA instruction repeats bM times.

It should be noted that in the embodiments of the present disclosure, since the result matrix C adopts the same layout on both the host memory and the accelerator memory, there is no need to use complicated data movement instruction(s) to realize on-the-fly layout conversion in the process of moving each slice of the result matrix C between the host memory and the accelerator memory. Therefore, it may be possible to reduce a lot of time spent on such data moving operation(s), and in turn improve computing efficiency.

In the above step S503, the accelerator may perform a matrix operation on the read first slice and the second slice to obtain a matrix operation result.

FIG. 9 shows another example of a slice-based matrix multiplication provided in the embodiments of the present disclosure. As shown in FIG. 9, the accelerator requires that the left matrix A adopts the zZ layout on the accelerator memory, the right matrix B adopts the nZ layout on the accelerator memory, and the matrix product of the two adopts the zN layout.

It should be noted that the layouts of the left and right matrices and matrix operations required by the accelerator depend on factors such as the specific types of matrix operations to be completed by the accelerator and the number of computing units in the accelerator. Therefore, FIG. 9 is merely an example of matrix multiplication performed on the accelerator. When the hardware design of the accelerator changes, the layouts of the left matrix, right matrix and result matrix on the accelerator will also change, and the specific solutions related to data movement operation(s) and layout conversion operation(s) of the left and right matrices will be affected.

In some embodiments, performing the vector operation on the third slice and the fourth slice to obtain the fifth slice of the result matrix (S504) may include:
if the third slice and the fourth slice on the accelerator memory are in different layouts, performing a layout conversion operation during the process of performing the vector operation on the third slice and the fourth slice to obtain the fifth slice of the result matrix.

Since the type of vector operation instructions of the accelerator may vary, different instruction parameters may be configured to realize on-the-fly layout conversion of operation data and operation result in the process of vector operation. Therefore, the parameter design of data movement instructions may be simplified to save time for data movement, and the computing efficiency may be further improved.

For example, the third slice, the fourth slice and the fifth slice each include a plurality of Nf×Nf fractals, each fractal is of a size of bM×bN, and the number of columns bN is equal to 8 blocks (1 block includes Nf elements). One vector accumulation instruction is used to complete the accumulation of a row of fractals in a slice, and one repeat of the vector accumulation instruction may complete the accumulation of one row of elements in a row of fractals. Therefore, each vector accumulation instruction needs to be repeated Nf times, and a total of bM/Nf vector accumulation instructions are needed.

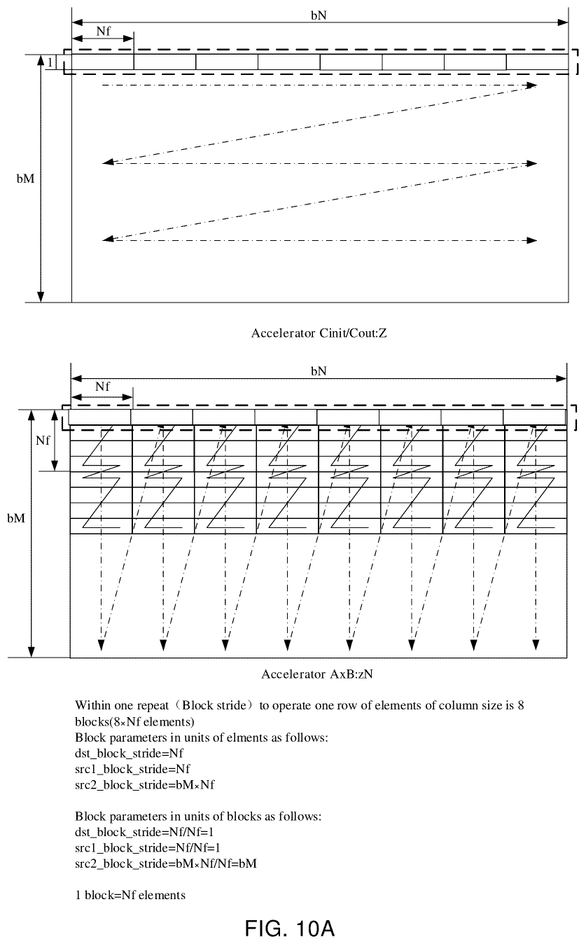

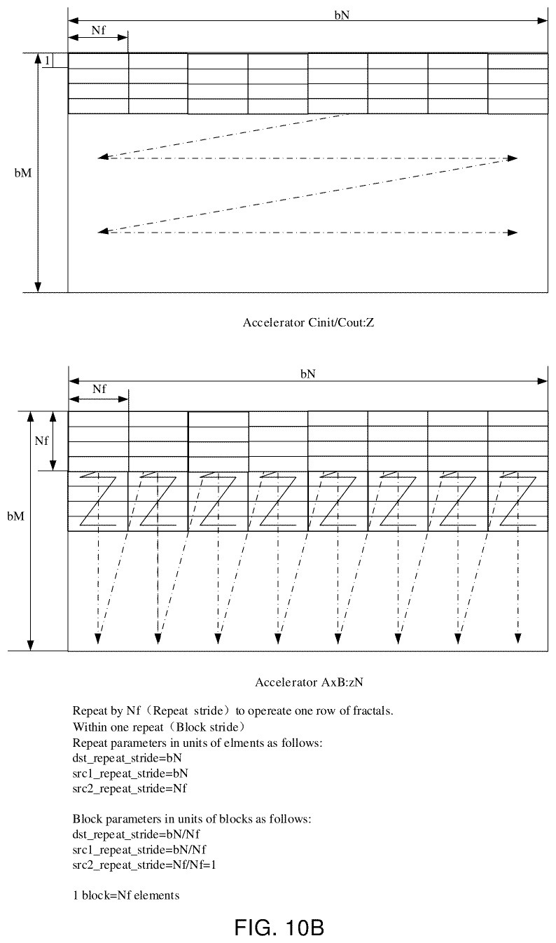

The examples of the vector accumulation will be described in detail below with reference to FIGS. 10A and 10B. Considering an example in which the third slice (Cinit) and the fifth slice (Cout) adopt Z layout on both the host memory and the accelerator memory and the fourth slice (A×B) adopts zN layout on the accelerator memory, the k-th vector operation instruction (where 1≤k≤(bM/Nf)) may include the following steps.

In step 1, as shown in FIG. 10A, during one repeat of the k-th vector instruction, a row of elements in the third slice and a row of elements in the fourth slice are accumulated to obtain a row of elements in the fifth slice.

In step 2, as shown in FIG. 10B, by repeating the step 1 Nf times, a row of fractals in the third slice and a row of fractals in the fourth slice are accumulated to obtain a row of fractals in the fifth slice.

Here, the parameter configuration of the kth vector accumulation instruction (where 1≤k≤(bM/Nf)) is as follows:

(1) Within one repeat, the instruction in units of elements has the following parameters:
dst_block_stride=Nf, which means that the destination block stride is Nf, which means that the number of elements between two adjacent blocks of the fifth slice on the accelerator memory is Nf;
src1_block_stride=Nf, which means that the source 1 block stride is Nf, which means that the number of elements between two adjacent blocks of the third slice on the accelerator memory is Nf; and
src2_block_stride=bM×Nf, which means that the source 2 block stride is bM×Nf, which means that the number of elements between two adjacent blocks of the fourth slice on the accelerator memory is bM×Nf;

(2) Within one repeat, the instruction in units of blocks has the following parameters:
dst_block_stride=1, which means that the destination block stride is 1, which means that the number of blocks between two adjacent blocks of the fifth slice on the accelerator memory is 1;
src1_block_stride=1, which means that the source 1 block stride is 1, which means that the number of blocks between two adjacent blocks of the third slice on the accelerator memory is 1; and
src2_block_stride=bM, which means that the source 2 block stride is bM, which means that the number of blocks between two adjacent blocks of the fourth slice on the accelerator memory is bM;

(3) Between two adjacent repeats, the instruction in units of elements has the following parameters:
dst_repeat_stride=bN, which means that the destination repeat stride is bN, which means that the number of elements between two adjacent repeats of the fifth slice on the accelerator memory is bN;
src1_repeat_stride=bN, which means that the source 1 repeat stride is bN, which means that the number of elements between two adjacent repeats of the third slice on the accelerator memory is bN; and
src2_repeat_stride=Nf, which means that the source 2 repeat stride is Nf, which means that the number of elements between two adjacent repeats of the fourth slice on the accelerator memory is Nf;

(4) Between two adjacent repeats, the instruction in units of blocks has the following parameters:
dst_repeat_stride=bN/Nf, which means that the destination repeat stride is bN/Nf, which means that the number of blocks between two adjacent repeats of the fifth slice on the accelerator memory is bN/Nf;
src1_repeat_stride=bN/Nf, which means that the source 1 repeat stride is bN/Nf, which means that the number of blocks between two adjacent repeats of the third slice on the accelerator memory is bN/Nf; and
src2_repeat_stride=Nf/Nf, which means that the source 2 repeat stride is Nf/Nf, which means that the number of blocks between two adjacent repeats of the fourth slice on the accelerator memory is Nf/Nf;
where 1 block=Nf elements.

It should be noted that the above parameters for vector accumulation are merely examples, and other solutions may also be adopted. For example, a fractal may be accumulated by one repeat of the k-th vector accumulation instruction, which is not limited in the embodiments of the present disclosure.

In addition, this example is described by taking an example in which the number of elements in a row of elements in the third slice, the fourth slice, or the fifth slice (i.e., the number of columns bN) is equal to the number of elements that can be accumulated by one repeat of one vector accumulation instruction, that is, bN=8 blocks=8×Nf elements. If the number of elements in a row of elements in the slice is greater than the number of elements that can be accumulated by one repeat of one vector accumulation instruction, that is, bN>(8×Nf), e.g., bN=16×Nf, the parameters of the vector accumulation instruction and the number of required vector accumulation instructions can be adjusted accordingly, which will not be limited in the embodiments of the present disclosure.

Furthermore, the three layout conversion manners, which are on-the-fly layout conversion during the data movement process, layout conversion in advance on the host memory, and on-the-fly layout conversion on the accelerator memory, may be comprehensively considered to flexibly determine a comprehensive strategy of the data movement, layout conversion and accelerator computation, which will not be limited in the embodiments of the present disclosure.

For example, a cost model can be used to evaluate the time efficiency of the above two or three layout conversion manners to determine a final strategy. For example, a strategy that minimizes the total time consumption of the data movement, accelerator operation, and layout conversion interspersed or coexisting during data movement and/or accelerator operation, may be selected as the final strategy, so as to improve the overall utilization of storage resources, data transmission resources, and computing resources and in turn improve the computing efficiency.

In some embodiments, the first 4D layout is row major both between and within fractals (denoted as zZ), the second 4D layout is column major within fractals and row major between fractals (denoted as nZ), and the third 4D layout is row major within fractals and column major between fractals (denoted as zN).

It should be noted that based on the resource configuration of the accelerator, such as computing resources (e.g., the number of multipliers, adders, etc.), storage resources (e.g., the number of storage units), computing resource layout requirements, software resources (e.g., types of instructions and configuration parameters), it may be possible to comprehensively design various strategies such as layouts of the left matrix, the right matrix and the result matrix on the accelerator memory and the host memory, data movement instructions, accelerator operation instructions, etc., to improve the operation efficiency as much as possible.

In S505, the fifth slice is moved from the accelerator memory to the host memory. In the embodiments of the present disclosure, since the result matrix C adopts the same layout on the host memory and the accelerator memory, only one DMA instruction is required to move the fifth slice of the result matrix C from the accelerator memory to the host memory.

For example, the result matrix C is of a size of M×N and adopts Z layout on both the host memory and the accelerator memory; and the fifth slice is of a size of bM×bN, and each fractal is a square matrix of Nf×Nf. Since the result matrix C adopts Z layout on both the host memory and the accelerator memory, no layout conversion is needed, and one DMA instruction may complete the moving operation of all elements in the fifth slice.

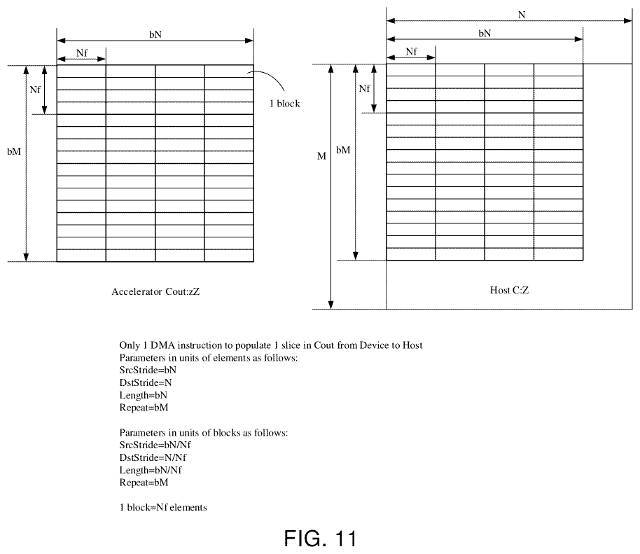

As shown in FIG. 11, the parameter configuration of the DMA instruction is as follows:

(1) DMA instruction in units of elements has the following parameters:
SrcStride=bN, which means that the source stride is bN, which means that the number of elements between two adjacent repeats on the accelerator memory is bN;
DstStride=Nf, which means that the destination stride is Nf, which means that the number of elements between two adjacent repeats on the host memory is Nf;
Length=bN, which means that the number of elements that can be moved by one repeat is bN, which means a row of elements in the fifth slice; and
Repeat=bM, which means repeating bM times, which means that the fifth slice has bM rows of elements and bM repeats are needed.

(2) DMA instruction in block units has the following parameters:
SrcStride=bN/Nf, which means that the source stride is bN/Nf, which means that the number of blocks between two adjacent repeats on the accelerator memory is bN/Nf;
DstStride=Nf/Nf=1, which means that the destination stride is 1, which means that the number of blocks between two adjacent repeats on the host memory is 1;
Length=bN/Nf, which means that the number of blocks that can be moved by one repeat is bN/Nf; and
Repeat=bM, which means repeating bM times.

It should be noted that, in the embodiments of the present disclosure, since the result matrix C adopts the same layout on both the host memory and the accelerator memory, there is no need to use complicated data movement instruction(s) to realize on-the-fly layout conversion in the process of moving each slice of the result matrix C between the host memory and the accelerator memory. Therefore, it may be possible to reduce a lot of time spent on such data moving operation(s), and in turn improve the computing efficiency.

The embodiments of the present disclosure provide a computer program product including instructions carried on a non-transitory computer-readable storage medium. The instructions, when executed by a computing device, cause the computing device to implement the acceleration method for matrix operations provided in the above embodiments of the present disclosure.

The embodiments of the present disclosure provide a non-transitory computer-readable storage medium having a computer program or instructions stored thereon. The computer program or the instructions, when executed by a computing device, cause the computing device to implement the acceleration method for matrix operations provided in the above embodiments of the present disclosure.

For example, the computer-readable storage medium includes, but is not limited to, a magnetic storage device (e.g., a hard disk, a floppy disk or a magnetic tape), an optical disk (e.g., a compact disk (CD), or a DVD), a smart card, and a flash memory device (e.g., an erasable programmable read-only memory (EPROM), a card, a stick or a key driver). Various computer-readable storage media described in the embodiments of the present disclosure may represent one or more devices and/or other machine-readable storage media, which are used for storing information. The term “computer-readable storage medium” may include, but is not limited to, wireless channels and various other media capable of storing, containing and/or carrying instructions and/or data.

The embodiments of the present disclosure provide a system on chip (SoC). The SoC includes a processing circuit and a non-transitory storage medium. The storage medium (e.g., non-transitory computer-readable storage medium) has computer program instructions stored thereon that, when executed by the processing circuit (e.g., a processor), cause the SoC to implement the acceleration method for matrix operations provided in the above embodiments of the present disclosure.

Beneficial effects of the computer-readable storage medium, the computer program product and the SoC are the same as the beneficial effects of the acceleration method for matrix operations as described in the above embodiments, which will not be repeated here.

It should be understood that the processor in the embodiments of the present disclosure may be a central processing unit (CPU), and the processor may also be other general-purpose processor, digital signal processors (DSP), application specific integrated circuit (ASIC), field programmable gate array (FPGA), or other programmable logic devices, discrete gate or transistor logic devices, discrete hardware components, etc. The general-purpose processor may be a microprocessor, or the processor may be any conventional processor.

It should also be understood that memory involved in the embodiments of the present disclosure may be a volatile memory or a non-volatile memory, or may include both volatile and non-volatile memories. The non-volatile memory may be a read-only memory (ROM), a programmable ROM (PROM), an erasable programmable read-only memory (EPROM), an electrically EPROM (EEPROM) or a flash memory. The volatile memory may be a random access memory (RAM), which acts as an external cache. By way of illustration, but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchronous link DRAM (SLDRAM)) and a direct rambus RAM (DR RAM).

The above embodiments may be implemented in whole or in part through software, hardware (e.g., circuit), firmware, or any combination thereof. In a case where the above embodiments are implemented by using a software program, the software program may be implemented in whole or in part in a form of a computer program product. The computer program product includes one or more computer instructions. When loaded and executed on a computer, the computer instructions generate some of all of the processes or functions provided in the embodiments of the present disclosure. The computer may be a general-purpose computer, a dedicated computer, a computer network, or any other programmable device. The computer instructions may be stored in a computer-readable storage medium, or transmitted from one computer-readable storage medium to another computer-readable storage medium. For example, the computer instructions may be transmitted from one website site, computer, server or data center to another website site, computer, server or data center through wired (e.g., coaxial cable, optical fiber, digital subscriber line (DSL)) or wireless (e.g., infrared, wireless, microwave) methods. The computer-readable storage medium may be any available medium that may be accessed by the computer, or a server, a data center or any other data storage device including one or more available media. The available medium may be a magnetic medium (e.g., a floppy disk, a magnetic disk or a magnetic tape), an optical medium (e.g., a digital versatile disk (DVD)), a semiconductor medium (e.g., a solid state drive (SSD)), or the like.

It should be understood that in the embodiments of the present disclosure, the size of the sequence numbers of the above-mentioned processes does not mean the order of execution. The execution order of the processes should be determined by their functions and internal logic, and should not limit the implementation processes in the embodiments of the present disclosure.

Those skilled in the art can realize that by combining modules and algorithm steps of the examples described in the embodiments of the present disclosure, the embodiments of the present disclosure can be implemented through electronic hardware or a combination of electronic hardware and computer software. Whether the functions are performed through the hardware or software depends on the specific application and restrictive conditions on design of the technical solution. Those skilled in the art may use different methods for each specific application to implement the described functions, but such implementation should not be considered beyond the scope of the present disclosure.

Those skilled in the art can clearly understand that for the convenience and simplicity of description, the specific working processes of the system, device and units described above can be referred to the corresponding processes in the foregoing method embodiments, and details will not be repeated here.

In several embodiments provided in the present disclosure, it will be understood that the disclosed systems, devices and methods may be implemented through other manners. For example, the device embodiments described above are merely exemplary. For example, the division of the functional modules or units is only a logical functional division. In actual implementation, there may be other division manners. For example, in some embodiments, a plurality of devices or components may be combined or integrated into another system, or some features may be ignored or not executed. In addition, the mutual coupling or direct coupling or communication connection shown or discussed may be an indirect coupling or communication connection through some interfaces, devices or modules, and may be an electrical connection, a mechanical connection or other forms of connections.

The units described as separate components may or may not be physically separated, and the components shown as units may or may not be physical units. That is, they may be located in one place, or may be distributed to multiple network units. Some or all of the units may be selected according to actual needs to achieve the purposes of the solutions in the embodiments.

In addition, the functional modules in the embodiments of the present disclosure may be integrated into a single device; or, the modules may be separate physical modules; or, two or more modules may be integrated into a single device.

If the functions implemented in the form of the software functional unit and sold or used as an independent product, it may be stored in a computer-readable storage medium. Based on this understanding, the technical solutions of the present disclosure may be essentially, or a part of the technical solutions of the present disclosure that contributes to the related technology, or a part of the technical solutions of the present disclosure may be, embodied in the form of a software product, and the computer software product may be stored in a storage medium and includes a plurality of instructions for enabling a computer device (which may be a personal computer, a server, a network device, etc.) to perform part or all of steps of the methods as described in the embodiments of the present disclosure. The storage medium includes various types of medium capable of storing program codes, such as a USB flash drive, a mobile disk, a ROM, a RAM, a magnetic disk, or an optical disk.

The foregoing descriptions are merely specific implementation manners of the present disclosure, but the protection scope of the present disclosure is not limited thereto. Any person skilled in the art could readily conceive of changes or replacements within the technical scope of the present disclosure, which shall all be included in the protection scope of the present disclosure. Therefore, the protection scope of the present disclosure should be subjected to the protection scope of the claims.

What is claimed is:

1. An acceleration method for performing matrix operations by a computing device, the computing device including a host memory and an accelerator memory, the host memory being used for storing a left matrix, a right matrix, and a result matrix, the method comprising:
moving a first slice of the left matrix and a second slice of the right matrix from the host memory to the accelerator memory, wherein the first slice on the accelerator memory is in a first 4-dimensional (4D) layout, and the second slice on the accelerator memory is in a second 4D layout;
moving a third slice of the result matrix from the host memory to the accelerator memory;
performing a matrix operation on the first slice and the second slice to obtain a fourth slice of the result matrix, wherein the fourth slice on the accelerator memory is in a third 4D layout;
performing a vector operation on the third slice and the fourth slice to obtain a fifth slice of the result matrix; and
moving the fifth slice from the accelerator memory to the host memory,
wherein the third slice and the fifth slice are in the same layout on the host memory and the accelerator memory.

2. The method of claim 1, wherein performing the vector operation on the third slice and the fourth slice to obtain the fifth slice of the result matrix, includes:
if the third slice and the fourth slice on the accelerator memory are in different layouts, performing a layout conversion operation during the process of performing the vector operation on the third slice and the fourth slice to obtain the fifth slice of the result matrix.

3. The method of claim 1, wherein the left matrix is in the same layout on the host memory and the accelerator memory; and/or the right matrix is in the same layout on the host memory and the accelerator memory.

4. The method of claim 1, wherein the left matrix is in different layouts on the host memory and the accelerator memory, and/or the right matrix is in different layouts on the host memory and the accelerator memory;
moving the first slice of the left matrix and the second slice of the right matrix from the host memory to the accelerator memory includes:
using one or more first data moving operations to move the first slice of the left matrix from the host memory to the accelerator memory, wherein the one or more first data moving operations are used to convert a layout of the first slice on the host memory into a layout of the first slice on the accelerator memory; and/or
using one or more second data moving operations to move the second slice of the right matrix from the host memory to the accelerator memory, wherein the one or more second data moving operations are used to convert a layout of the second slice on the host memory into a layout of the second slice on the accelerator memory.

5. The method of claim 1, wherein the left matrix is in different layouts on the host memory and the accelerator memory, and/or the right matrix is in different layouts on the host memory and the accelerator memory;
before moving the first slice of the left matrix and the second slice of the right matrix from the host memory to the accelerator memory, the method further comprises:
converting a layout of the left matrix or the first slice on the host memory into the first 4D layout; and/or
converting a layout of the right matrix or the second slice on the host memory into the second 4D layout.

6. The method of claim 1, wherein the first 4D layout is row major both between and within fractals, the second 4D layout is column major within fractals and row major between fractals, and the third 4D layout is row major within fractals and column major between fractals.

7. The method of claim 1, wherein the first slice includes one or more first fractals, the second slice includes one or more second fractals, and the third slice, the fourth slice and the fifth slice each include one or more third fractals;
the first slice is a bM by bK sub-matrix, the second slice is a bK by bN sub-matrix, and the third slice, the fourth slice and the fifth slice are each a bM by bN sub-matrix;
each first fractal is an fM by fK sub-matrix, each second fractal is an fK by fN sub-matrix, and each third fractal is an fM by fN sub-matrix;
wherein mod (bM, fM)=0, mod (bK, fK)=0, and mod (bN, fN)=0.

8. A computing device, comprising:
a memory;
a host;
an accelerator;
a host memory for storing a left matrix, a right matrix, and a result matrix; and
an accelerator memory;
wherein the memory is configured to store computer instructions that, when executed by the host and the accelerator, cause the computing device to implement:
moving a first slice of the left matrix and a second slice of the right matrix from the host memory to the accelerator memory, wherein the first slice on the accelerator memory is in a first 4D layout, and the second slice on the accelerator memory is in a second 4D layout;
moving a third slice of the result matrix from the host memory to the accelerator memory;
performing a matrix operation on the first slice and the second slice to obtain a fourth slice of the result matrix, wherein the fourth slice on the accelerator memory is in a third 4D layout;
performing a vector operation on the third slice and the fourth slice to obtain a fifth slice of the result matrix; and
moving the fifth slice from the accelerator memory to the host memory,
wherein the third slice and the fifth slice are in the same layout on the host memory and the accelerator memory.

9. The computing device of claim 8, wherein the computer instructions that, when executed by the host and the accelerator, cause the computing device to implement:
if the third slice and the fourth slice on the accelerator memory are in different layouts, performing a layout conversion operation during the process of performing the vector operation on the third slice and the fourth slice to obtain the fifth slice of the result matrix.

10. The computing device of claim 8, wherein the left matrix is in the same layout on the host memory and the accelerator memory; and/or the right matrix is in the same layout on the host memory and the accelerator memory.

11. The computing device of claim 8, wherein the left matrix is in different layouts on the host memory and the accelerator memory, and/or the right matrix is in different layouts on the host memory and the accelerator memory;
the computer instructions that, when executed by the host and the accelerator, cause the computing device to implement:
using one or more first data moving operations to move the first slice of the left matrix from the host memory to the accelerator memory, wherein the one or more first data moving operations are used to convert a layout of the first slice on the host memory into a layout of the first slice on the accelerator memory; and/or
using one or more second data moving operations to move the second slice of the right matrix from the host memory to the accelerator memory, wherein the one or more second data moving operations are used to convert a layout of the second slice on the host memory into a layout of the second slice on the accelerator memory.

12. The computing device of claim 8, wherein the left matrix is in different layouts on the host memory and the accelerator memory, and/or the right matrix is in different layouts on the host memory and the accelerator memory;
the computer instructions that, when executed by the host and the accelerator, cause the computing device to further implement:
before moving the first slice of the left matrix and the second slice of the right matrix from the host memory to the accelerator memory, converting a layout of the left matrix or the first slice on the host memory into the first 4D layout and/or converting a layout of the right matrix or the second slice on the host memory into the second 4D layout.

13. The computing device of claim 8, wherein the first 4D layout is row major both between and within fractals, the second 4D layout is column major within fractals and row major between fractals, and the third 4D layout is row major within fractals and column major between fractals.

14. The computing device of claim 8, wherein the first slice includes one or more first fractals, the second slice includes one or more second fractals, and the third slice, the fourth slice and the fifth slice each include one or more third fractals;
the first slice is a bM by bK sub-matrix, the second slice is a bK by bN sub-matrix, and the third slice, the fourth slice and the fifth slice are each a bM by bN sub-matrix;
each first fractal is an fM by fK sub-matrix, each second fractal is an fK by fN sub-matrix, and each third fractal is an fM by fN sub-matrix;
wherein mod (bM, fM)=0, mod (bK, fK)=0, and mod (bN, fN)=0.

15. A non-transitory computer-readable storage medium having instructions stored thereon, which when executed by a computing device including a host memory and an accelerator memory, causes the computing device to perform a method comprising:
moving a first slice of a left matrix and a second slice of a right matrix from the host memory to the accelerator memory, wherein the first slice on the accelerator memory is in a first 4D layout, and the second slice on the accelerator memory is in a second 4D layout;
moving a third slice of a result matrix from the host memory to the accelerator memory;
performing a matrix operation on the first slice and the second slice to obtain a fourth slice of the result matrix, wherein the fourth slice on the accelerator memory is in a third 4D layout;
performing a vector operation on the third slice and the fourth slice to obtain a fifth slice of the result matrix; and
moving the fifth slice from the accelerator memory to the host memory,
wherein the third slice and the fifth slice are in the same layout on the host memory and the accelerator memory.

16. The non-transitory computer-readable storage medium of claim 15, wherein the instructions that, when executed by the computing device, cause the computing device to perform the method comprising:
if the third slice and the fourth slice on the accelerator memory are in different layouts, performing a layout conversion operation during the process of performing the vector operation on the third slice and the fourth slice to obtain the fifth slice of the result matrix.

17. The non-transitory computer-readable storage medium of claim 15, wherein the left matrix is in the same layout on the host memory and the accelerator memory; and/or the right matrix is in the same layout on the host memory and the accelerator memory.

18. The non-transitory computer-readable storage medium of claim 15, wherein the left matrix is in different layouts on the host memory and the accelerator memory and/or the right matrix is in different layouts on the host memory and the accelerator memory;
the instructions that, when executed by the computing device cause the computing device to perform the method comprising:
using one or more first data moving operations to move the first slice of the left matrix from the host memory to the accelerator memory, wherein the one or more first data moving operations are used to convert a layout of the first slice on the host memory into a layout of the first slice on the accelerator memory; and/or
using one or more second data moving operations to move the second slice of the right matrix from the host memory to the accelerator memory, wherein the one or more second data moving operations are used to convert a layout of the second slice on the host memory into a layout of the second slice on the accelerator memory.

19. The non-transitory computer-readable storage medium of claim 15, wherein the left matrix is in different layouts on the host memory and the accelerator memory and/or the right matrix is in different layouts on the host memory and the accelerator memory;
the instructions that, when executed by the computing device, cause the computing device to perform the method further comprising:
before moving the first slice of the left matrix and the second slice of the right matrix from the host memory to the accelerator memory, converting a layout of the left matrix or the first slice on the host memory into the first 4D layout and/or converting a layout of the right matrix or the second slice on the host memory into the second 4D layout.

20. The non-transitory computer-readable storage medium of claim 15, wherein the first 4D layout is row major both between and within fractals, the second 4D layout is column major within fractals and row major between fractals, and the third 4D layout is row major within fractals and column major between fractals.
